(19) United States
(12) Patent Application Publication
(10) Pub. No.: US 2010/0207922 A1
(43) Pub. Date: Aug. 19, 2010

(54) PLASMA DISPLAY PANEL AND METHOD FOR MANUFACTURING THE SAME

(76) Inventors: Yasuhisa Ishikura, Osaka (JP); Eiichi Uriu, Osaka (JP); Ryota Hamada, Hyogo (JP); Tomohiro Murakoso, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/669,100

(22) PCT Filed: Jul. 3, 2009
(86) PCT No.: PCT/JP2009/003087

§ 371 Date: Jan. 14, 2010

(30) Foreign Application Priority Data
Jul. 4, 2008 (JP) 2008-175412

(51) Int. Cl. G09G 3/28; G06F 3/038; H01J 9/02

(52) U.S. Cl. 345/211; 445/24; 345/68

(57) ABSTRACT

Having a low-cost transparent electrode, the plasma display panel suppresses variations in discharge characteristics between discharge cells and provides high quality image. To attain above, a scan electrode has a scan transparent electrode formed by applying a dispersion liquid containing particles of metal or metal oxide onto a front substrate, and a scan bus electrode on the front substrate. A sustain electrode has a sustain transparent electrode formed by applying a dispersion liquid containing particles of metal or particles of metal oxide onto the front substrate, and a sustain bus electrode on the front substrate. Besides, a discharge gap is formed by a scan bus electrode and a sustain bus electrode. An outer periphery section on a discharge-gap side of a scan transparent electrode overlaps with a scan bus electrode, and an outer periphery section on a discharge-gap side of a sustain transparent electrode overlaps with a sustain bus electrode.

### TECHNICAL FIELD

The present invention relates to an AC surface discharge-type plasma display panel used for a display device and also relates to a method for manufacturing the panel.

### BACKGROUND ART

An AC surface discharge-type plasma display panel, which has become dominance in plasma display panel (hereinafter simply referred to as a panel), has a front panel and a back panel oppositely disposed with each other and a plurality of discharge cells therebetween. The front panel has a glass front substrate, display electrode pairs each of which formed of a scan electrode and a sustain electrode, a dielectric layer and a protective layer that cover them. The back panel has a glass back substrate, data electrodes, a dielectric layer that covers the electrodes, barrier ribs, and phosphor layers. The front panel and the back panel are oppositely disposed and sealed with each other so that the display electrode pairs are located orthogonal to the data electrodes. The discharge space formed between the two panels is filled with discharge gas. The discharge cells are formed at which the display electrode pairs face the data electrodes. In the panel with the structure above, a gas discharge is generated in each discharge cell to excite phosphors of red, green, and blue. Color display is thus attained.

Each of the scan electrodes and the sustain electrodes is formed in a manner that, for example, a bus electrode of a narrow stripe is disposed on a transparent electrode of a wide stripe. To form the transparent electrode, for example, a thin film of indium tin oxide (ITO) formed on the front substrate by sputtering undergoes patterning by a photolithography method so as to be formed into a stripe shape. To form the bus electrode, paste of silver (Ag) is printed into a stripe shape on the transparent electrode and then fired (for example, see patent literature 1). However, to form an indium-tin-oxide (ITO) thin film by sputtering, it becomes necessary to prepare a vacuum equipment and an photolitohgrapy equipment, that is, needs a large production facility. Besides, the forming process above has a problem of low productivity and high cost.

To address the problems above, some methods for forming a transparent electrode have been introduced. For example, a dispersion liquid containing particles of metal chosen from indium (In), tin (Sn), antimony (Sb), aluminum (Al), and zinc (Zn) is applied and fired to form a transparent electrode (for example, see patent literature 2).

According to another method (see patent literature 3, for example), a dispersion liquid is prepared in a manner that powder of indium-tin-oxide (ITO) superfine particles is dissolved into an organic solvent. The crystal grain boundary of the ITO superfine particles above is grown by firing a composite oxide of indium tin oxide (ITO) having indium (In) and tin (Sn) as an essential component at 350 to 800° C.

A screen printing method and an inkjet method can be employed for applying dispersion liquid; however, the patterning by the aforementioned thick film printing has the limitations of dimensional accuracy. Therefore, it has been difficult to form a transparent electrode having dimensional accuracy suitable for a panel. In particular, the distance between a scan electrode and a sustain electrode in a discharge cell, i.e., the distance of a discharge gap significantly affects discharge characteristics of the discharge cell. Large variations in discharge gap due to poor dimensional accuracy of a transparent electrode increase variations in discharge characteristics between discharge cells. This has brought mura in display and impaired the quality of image display.

### CITATION LIST

### Patent Literature

PATENT LITERATURE 1: Unexamined Japanese Patent Publication No. 2000-156168

PATENT LITERATURE 2: Unexamined Japanese Patent Publication No. 2005-183054

PATENT LITERATURE 3: Unexamined Japanese Patent Publication No. 2005-166350

### SUMMARY OF THE INVENTION

The panel of the present invention having a plurality of display electrode pairs, each of which is formed of a pair of a scan electrode and a sustain electrode and a discharge gap therebetween, is characterized by the following structure. A scan electrode has a scan transparent electrode, which is formed by applying a dispersion liquid containing particles of metal or particles of metal oxide onto the front substrate, and a scan bus electrode disposed on the front substrate. Similarly, a sustain electrode has a sustain transparent electrode, which is formed by applying a dispersion liquid containing particles of metal or metal oxide onto the front substrate, and a sustain bus electrode disposed on the front substrate. A discharge gap is formed by a scan bus electrode and a sustain bus electrode. An outer periphery section on the discharge gap side of the scan transparent electrode overlaps with the scan bus electrode. Similarly, an outer periphery section on the discharge gap side of the sustain transparent electrode overlaps with the sustain bus electrode.

Such structured panel achieves low cost and small variations in discharge characteristics between discharge cells, providing excellent image display with high quality.

### BRIEF DESCRIPTION OF THE DRAWINGS

FIG. 1 is an exploded perspective view showing the structure of the panel in accordance with a first exemplary embodiment of the present invention.

FIG. 2A is a front view, seen from the front panel side, showing the detailed structure of the display electrode pairs of the panel.

FIG. 2B is a sectional view of the front panel showing the detailed structure of the display electrode pairs of the panel.

FIG. 3A is a view illustrating a method for manufacturing the front panel of the panel.

FIG. 3B is a view illustrating the method for manufacturing the front panel of the panel.

FIG. 3C is a view illustrating the method for manufacturing the front panel of the panel.

FIG. 3D is a view illustrating the method for manufacturing the front panel of the panel.

FIG. 3E is a view illustrating the method for manufacturing the front panel of the panel.

FIG. 4A is a view illustrating the method for manufacturing the back panel of the panel.

FIG. 4B is a view illustrating the method for manufacturing the back panel of the panel.

FIG. 4C is a view illustrating the method for manufacturing the back panel of the panel.

FIG. 4D is a view illustrating the method for manufacturing the back panel of the panel.

FIG. 4E is a view illustrating the method for manufacturing the back panel of the panel.

FIG. 5A is a view illustrating a method for manufacturing the front panel of the panel in accordance with a second exemplary embodiment of the present invention.

FIG. 5B is a view illustrating the method for manufacturing the front panel of the panel.

FIG. 5C is a view illustrating the method for manufacturing the front panel of the panel.

FIG. 5D is a view illustrating the method for manufacturing the front panel of the panel.

FIG. 5E is a view illustrating the method for manufacturing the front panel of the panel.

FIG. 6 is a view showing the detailed structure of the display electrode pairs of the panel in accordance with a third exemplary embodiment of the present invention.

### DETAILED DESCRIPTION OF THE PREFERRED EMBODIMENTS

The exemplary embodiments of the present invention are described hereinafter with reference to the accompanying drawings.

### First Exemplary Embodiment

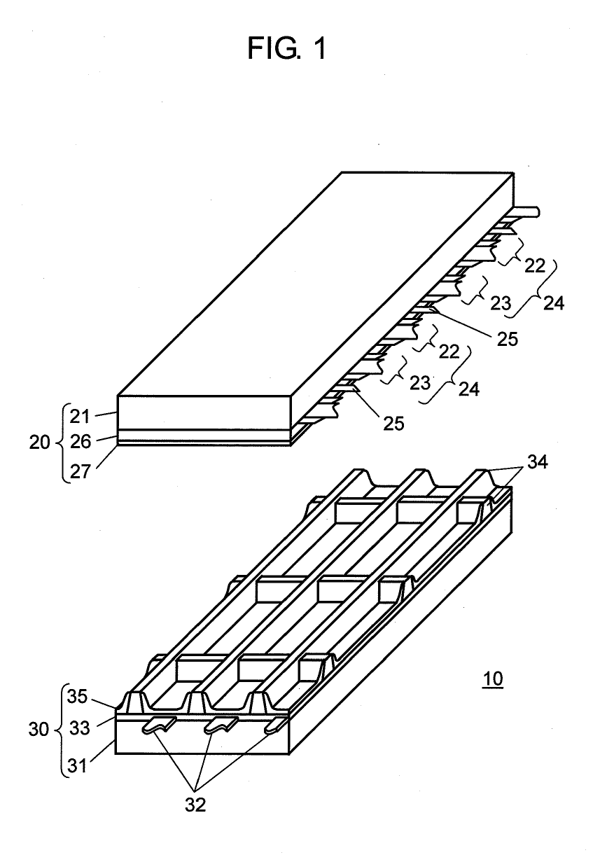

FIG. 1 is an exploded perspective view showing the structure of the panel in accordance with the first exemplary embodiment of the present invention. Panel 10 has a structure where oppositely disposed front panel 20 and back panel 30 are sealed at the peripheries with sealing material (not shown) and a plurality of discharge cells are formed inside.

Front panel 20 has glass-made front substrate 21, display electrode pairs 24 formed of scan electrodes 22 and sustain electrodes 23, black stripes 25, dielectric layer 26, and protective layer 27. On front substrate 21, display electrode pairs 24, each of which is a pair of scan electrode 22 and sustain electrode 23, are formed in parallel with each other. Besides, black stripe 25 is formed between adjacent display electrode pairs 24.

Although FIG. 1 shows an arrangement where scan electrode 22, sustain electrode 23, black stripe 25, scan electrode 22, sustain electrode 23, black stripe 25 are repeatedly disposed in the order named, it is not limited to; display electrode pairs 24 and black stripe 25 may be arranged in the following order: scan electrode 22, sustain electrode 23, black stripe 25, sustain electrode 23, scan electrode 22, black stripe 25, scan electrode 22, sustain electrode 23, black stripe 25, sustain electrode 23, scan electrode 22, black stripe 25, and so on.

Dielectric layer 26 is formed so as to cover display electrode pairs 24 and black stripes 25, and protective layer 27 is formed over dielectric layer 26.

Back panel 30 has glass-made back substrate 31, data electrodes 32, base dielectric layer 33, barrier ribs 34, and phosphor layers 35. A plurality of data electrodes 32 are formed in parallel with each other on back substrate 31. Base dielectric layer 33 is formed so as to cover data electrodes 32, and grid-like barrier ribs 34 are formed on base dielectric layer 33. In addition, phosphor layers 35 of red, green, and blue are formed on the surface of base dielectric layer 33 and on the side surface of barrier ribs 34.

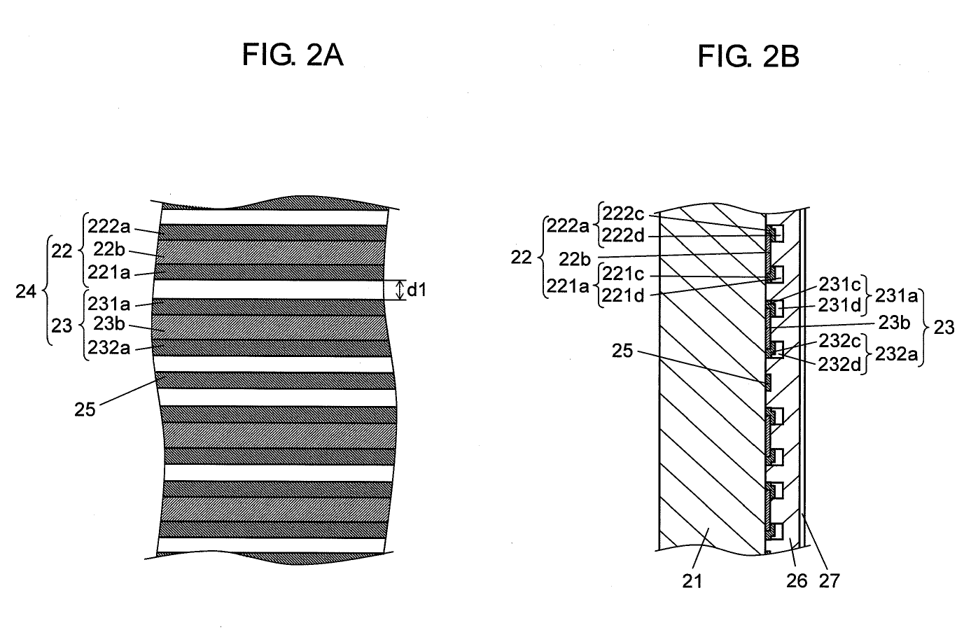

FIG. 2A is a front view seen from the front panel side, which shows the detailed structure of the display electrode pairs of the panel in accordance with the first exemplary embodiment of the present invention. FIG. 2B is a sectional view of the front panel and shows the detailed structure of the display electrode pairs of the panel in accordance with the first exemplary embodiment of the present invention.

Scan electrode 22 has two opaque scan bus electrodes 221a and 222a, and transparent scan transparent electrode 22b. Similarly, sustain electrode 23 has two sustain bus electrodes 221a and 232a, and sustain transparent electrode 23b. A discharge gap having distance d1 is formed between scan bus electrode 221a and sustain bus electrode 231a.

Scan bus electrode 221a is formed of black layer 221c and conductive layer 221d, and scan bus electrode 222a is formed of black layer 222c and conductive layer 222d. Similarly, sustain bus electrode 231a is formed of black layer 231c and conductive layer 231d, and sustain bus electrode 232a is formed of black layer 232c and conductive layer 232d. Hereinafter, scan bus electrodes 221a and 222a are simply referred to as bus electrodes 221a and 222a; sustain bus electrodes 231a and 232a are referred to as bus electrodes 231a and 232a; scan transparent electrode 22b is referred to as transparent electrode 22b; and sustain transparent electrode 23b is referred to as transparent electrode 23b.

Black layers 221c, 222c, 231c, and 232c are formed for making bus electrodes 221a, 222a, 231a, and 232a look black, respectively, when panel 10 is seen from the display side. The black layers are formed of a black material, for example, having ruthenium oxide (RuO₂) as the main component and are formed into a narrow stripe shape on front substrate 21. Conductive layers 221d, 222d, 231d, and 232d are formed on black layers 221c, 222c, 231c, and 232c, respectively. The conductive layer has a layered structure of conductive material including silver (Ag), allowing bus electrodes 221a, 222a, 231a, and 232a to have enhanced conductivity.

Black stripes 25 are formed for making the display surface look black when panel 10 is seen from the display surface side. Although the black stripe of the embodiment is formed of a black material containing ruthenium oxide (RuO₂) as the main component, other materials that look black, for example, a material containing black pigment as the main component may be employed. Black stripes 25 are not an essential component, but it is effective in displaying image with high contrast against darkened display surface.

Transparent electrodes 22b and 23b are disposed not only for generating a strong electric field and accordingly generating a discharge in the discharge space, but also for drawing light generated from phosphor layers 35 outside panel 10. Each of transparent electrodes 22b and 23b is formed in a manner that a dispersion liquid containing particles of metal or particles of metal oxide chosen from indium (In), tin (Sn), antimony (Sb), aluminum (Al), and zinc (Zn) is applied so as to have a wide stripe shape and dried in a nonoxidizing atmosphere, and then fired in an oxidizing atmosphere.

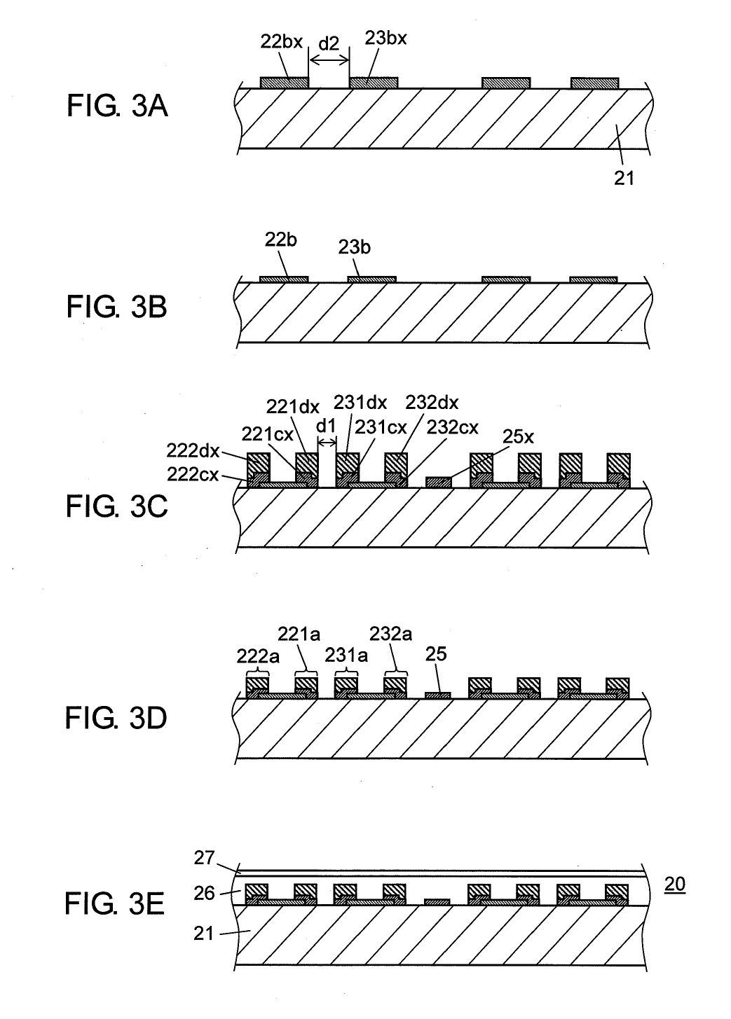

Next, the manufacturing method of panel 10 will be described. FIGS. 3A, 3B, 3C, 3D, and 3E are the views for illustrating the method for manufacturing the front panel of the panel in accordance with the first exemplary embodiment of the present invention.

As the first step of manufacturing front panel 20, glass-made front substrate 21 undergoes alkali cleaning.

Next, transparent electrodes 22b and 23b are formed. First, a dispersion liquid containing any one of the following particles with an average particle diameter of 5 to 100 nm is prepared:
particles of metal formed of at least one of indium (In), tin (Sn), antimony (Sb), aluminum (Al), and zinc (Zn);
particles of metal oxide formed of at least one of the metals above (where, the particles may be composite oxide particles that contain two or more elements of the metals above);
particles of alloy formed of two or more metals above; and
a mixture of the particles above.

In the embodiment, the dispersion liquid is formed in a manner that particles of indium (In)-tin (Sn) alloy with an average particle diameter of 10 nm is dispersed at a concentration of 12 wt % into an organic solvent with dispersant. In the embodiment, decahydronaphthalene is used for die organic solvent. Instead, for example, the followings can be employed: nonpolar solvent, such as toluene, xylene, benzene, tetradecane; aromatic hydrocarbon group; long-chain alkane, such as hexane, heptane, octane, nonane, decane, undecane, dodecane, tridecane, tetradecane, pentadecane, hexadecane, octadecane, nonadecane, eicosane, trimethylpentane; and cyclic alkane, such as cyclohexaane, cycloheptane, cyclooctane.

Next, as shown in FIG. 3A, wet layers 22bx and 23bx are formed by applying the dispersion liquid so as to have a wide stripe shape. In the embodiment, wet layers 22bx and 23bx for transparent electrodes 22b and 23b are formed with an inkjet applying equipment having a minute nozzle with many holes. At that time, the dispersion liquid is applied so that distance d2 between wet layers 22bx and 23bx on the discharge gap side is greater than distance d1 of a discharge gap.

After that, as shown in FIG. 3B, front substrate 21 having wet layers 22bx and 23bx is dried and fired at temperatures ranging from 400° C. to 600° C. in an oxidizing atmosphere. Through the process, transparent electrodes 22b and 23b, which are made of a transparent conductive film with a thickness of 80 to 1000 nm, are formed. In the embodiment, front substrate 21 having wet layers 22bx and 23bx formed thereon is dried while maintained for 10 min. at a temperature of 230° C. under reduced pressure of 1×10⁻³ Pa. After that, it is fired for 60 min. at a temperature of 500° C. in the air, so that transparent electrodes 22b and 23b, which are made of indium-tin oxide (ITO) film with a thickness of approx. 300 nm, are formed.

After that, as shown in FIG. 3C, precursors 221cx, 222cx, 231cx, 232cx for black layers 221c, 222c, 231c, 232c, respectively, and precursor 25x for black stripe 25 are formed. The precursors are made of black layer paste containing ruthenium oxide (RuO₂) and black pigment as the main component. Next, precursors 221dx, 222dx, 231dx, 232dx for conductive layers 221d, 222d, 231d, 232d are formed on precursors 221cx, 222cx, 231cx, 232cx. The precursors for the conductive layers are made of conductive layer paste containing silver (Ag).

The “precursor” termed in the present invention is the applied paste for structure member, such as black layer paste, that undergoes a thermal process until a state where an organic component originally contained in the paste has been removed and an inorganic component does not melt.

At that time, the precursors above are formed so as to satisfy the following conditions:
precursor 221cx covers the outer periphery section on the discharge gap side of transparent electrode 22b, and precursor 231cx covers the outer periphery section on the discharge gap side of transparent electrode 23b;
the distance between precursor 221cx and precursor 231cx equals to distance d1 of a discharge gap; and
precursor 222cx overlaps with at least a part of transparent electrode 22b, and precursor 232cx overlaps with at least a part of transparent electrode 23b.

Bus electrodes 221a and 231a form a discharge gap, that is, the precursors therefor, i.e., 221cx, 231cx, 221dx, and 231dx need to be formed with dimensional accuracy. In the exemplary embodiment, photosensitive black layer paste is applied over the entire surface of front substrate 21 by screen printing and then exposed with an exposure mask. After that, photosensitive conductive layer paste is applied over the entire surface of front substrate 21 by screen printing and then exposed with an exposure mask. Further, the applied paste undergoes a developing process. Precursors 221cx, 222cx, 231cx, 232cx, 25x, 221dx, 222dx, 231dx, and 232dx are thus obtained.

Next, as shown in FIG. 3D, bus electrodes 221a, 222a, 231a, 232a, and black stripe 25 are formed by firing front substrate 21 on which precursors 221cx, 222cx, 231cx, 232cx, 25x, 221dx, 222dx, 231dx, and 232dx have been formed. The peak temperature in the firing process should preferably be 550° C. to 600° C. In the embodiment, it is set at 580° C. In addition, the thickness of bus electrodes 221a, 222a, 231a, and 232a should preferably be 1 to 6 μm. In the embodiment, it is determined at 4 μm.

Next, as shown in FIG. 3E, dielectric layer 26 and protective layer 27 are formed on front substrate 21 on which scan electrodes 22, sustain electrodes 23, and black stripes 25 have been formed.

First, the precursor for dielectric layer 26 is formed by screen printing or other heretofore known technique. The precursor for dielectric layer 26 is fired so as to form dielectric layer 26 with a thickness of 20 to 50 μm.

The dielectric paste formed in the embodiment contains dielectric glass having the following composition: 34.6 wt % boron oxide (B₂O₃), 1.4 wt % silicon oxide (SiO₂), 27.6 wt % zinc oxide (ZnO), 3.3 wt % barium oxide (BaO), 25 wt % bismuth oxide (Bi₂O₃), 1.1 wt % aluminum oxide (Al₂O₃), 4.0 wt % molybdenum oxide (MoO₃), and 3.0 wt % tungsten oxide (WO₃). The softening point of the dielectric glass is about 570° C. Next, the precursor (not shown) for dielectric layer 26 is formed by applying dielectric paste, by die coating, onto front substrate 21 having scan electrodes 22, sustain electrodes 23, and black stripes 25 thereon. The precursor (not shown) for dielectric layer 26 is then fired at about 590° C., so that dielectric layer 26 with a thickness of about 40 μm is formed.

Instead of the dielectric paste above, for example, a dielectric paste containing dielectric glass that has a softening point of 520° C. to 590° C. and contains some of the followings can be used: boron oxide (B₂O₃), silicon oxide

(SiO₂), zinc oxide (ZnO), bismuth oxide (Bi₂O₃), aluminum oxide (Al₂O₃), molybdenum oxide (MoO₃), tungsten oxide (WO₃), cerium oxide (CeO), alkaline-earth metal oxide, and alkali metal oxide.

Protective layer 27 having magnesium oxide (MgO) as the main component is formed on dielectric layer 26 by a vacuum deposition method or other heretofore known technique.

In the embodiment, transparent electrodes 22b and 23b are formed of indium tin oxide (ITO) with the use of particles of indium (In)-tin (Sn) alloy, but it is not limited thereto. For example, the transparent electrodes may be formed with the use of particles of metal or particles of metal oxide containing indium (In) and tin (Sn). As another possibility, the transparent electrodes may be formed of a tin oxide (SnO₂) film with the use of particles of tin (Sn). As still another possibility, the transparent electrodes may be formed of a zinc oxide (ZnO) film with the use of particles of zinc (Zn). As yet another possibility, the transparent electrodes may be formed of indium tin oxide (ITO) with the use of particles of indium tin oxide (ITO), tin oxide (SnO₂) with the use of particles of tin oxide (SnO₂), or a zinc oxide (ZnO) film with the use of particles of zinc oxide (ZnO).

In the embodiment, after wet layers 22bx and 23bx are fired, precursors 221cx, 222cx, 231cx, 232cx, 221dx, 222dx, 231dx, and 232dx for black layers 221c, 222c, 231c, 232c, conductive layers 221d, 222d, 231d, 232d are formed and fired, but it is not limited thereto. For example, scan electrodes 22 and sustain electrodes 23 may be formed in a manner that precursors 221cx, 222cx, 231cx, 232cx, 221dx, 222dx, 231dx, and 232dx for black layers 221c, 222c, 231c, 232c, conductive layers 221d, 222d, 231d, 232d are formed on wet layers 22bx and 23bx and then the precursors and the wet layers are fired at the same time. Next, the method for manufacturing back panel 30 will be described.

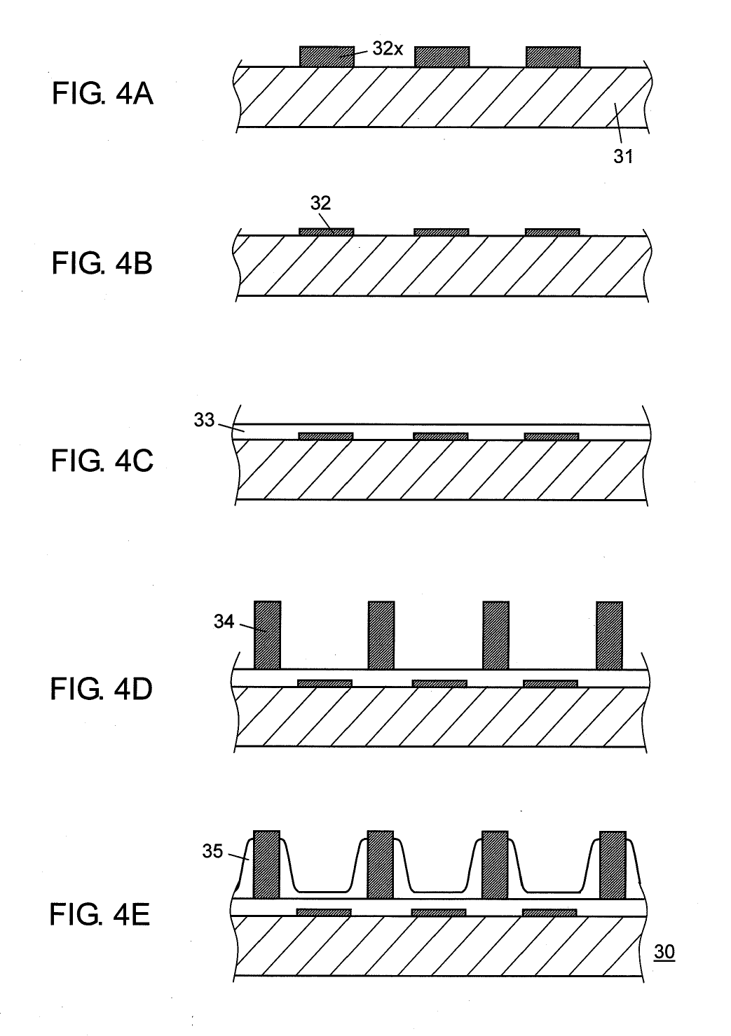

FIGS. 4A, 4B, 4C, 4D, and 4E illustrate the method for manufacturing the back panel of the panel in accordance with the first exemplary embodiment of the present invention.

First, as shown in FIG. 4A, conductive layer paste having silver (Ag) as the main component is applied onto back substrate 31 so as to have an evenly spaced stripe shape by heretofore known technique, for example, screen printing and photolithography. Precursors 32x for data electrodes 32 are thus formed.

Next, as shown in FIG. 4B, data electrodes 32 are formed by firing back substrate 31 having precursors 32x thereon. Data electrode 32 has a thickness of, for example, 2 to 10 μm. In the embodiment, the thickness is 3 μm.

Next, as shown in FIG. 4C, dielectric paste is applied onto back substrate 31 having data electrodes 32 thereon and then fired so as to form base dielectric layer 33. Base dielectric layer 33 has a thickness of, for example, approx. 5 to 15 μm. In the embodiment, the thickness is 10 μm.

Next, as shown in FIG. 4D, after photosensitive dielectric paste is applied onto back substrate 31 having base dielectric layer 33 thereon, the paste is dried so as to form the precursor for barrier ribs 34. After that, barrier ribs 34 are formed by photolithography or other heretofore known technique. Barrier ribs 34 have a height of, for example, 100 to 150 μm. In the embodiment, the height is 120 μm.

Next, as shown in FIG. 4E, phosphor ink containing any one of red, green, and blue phosphors is applied to the wall surface of barrier ribs 34 and the surface of dielectric layer 33. After that, the ink is dried and then fired so as to form phosphor layers 35.

A red phosphor may be formed of, for example, (Y, Gd) BO₃:Eu, (Y, V) PO₄:Eu. A green phosphor may be formed of, for example, Zn₂SiO₄:Mn, (Y, Gd) BO₃:Tb, (Y, Gd) Al₃(BO₃)₄:Tb. A blue phosphor may be formed of, for example, BaMgAl₁₀O₁₇:Eu, Sr₃MgSi₂O₈:Eu.

Front panel 20 and back panel 30 described above are oppositely disposed so that display electrode pairs 24 are positioned orthogonal to data electrodes 32. The two panels are sealed with low-melting glass at the peripheries outside the image display area where the discharge cells are formed. After that, the discharge space inside the panels is filled with discharge gas containing xenon (Xe). Panel 10 is thus completed.

According to the method of the embodiment, transparent electrodes 22b and 23b are formed with an inkjet applying equipment as described above.

Employing an inkjet method allows a dispersion liquid to be applied to a desired position, thereby reducing wasted use of material. As another advantage, the method easily applies ink into a complicated pattern. On the other hand, according to the inkjet method, dimensional accuracy is determined by a spot diameter at the landing of a droplet of ink. This makes difficult to obtain printing with high dimensional accuracy.

According to the method of the embodiment, however, bus electrode 221a is formed so as to cover the outer periphery section on the discharge gap side of transparent electrode 22b, and similarly, bus electrode 231a is formed so as to cover the outer periphery section on the discharge gap side of transparent electrode 23b. Distance d1 of a discharge gap is not determined by the distance between transparent electrodes 22b and 23b but determined by the distance between bus electrodes 221a and 231a formed with high dimensional accuracy. The method of the embodiment allows a discharge gap to be formed with high dimensional accuracy, contributing to suppressed variations in discharge characteristics between discharge cells.

According to the embodiment, transparent electrodes 22b and 23b are formed in a manner that a dispersion liquid—in which indium (In)-tin (Sn) alloy particles with an average diameter of 10 nm is dispersed at high concentration—is applied, dried, and then fired at a high temperature of 500° C. Such formed transparent electrodes not only have low resistance, high transmittance, but also keep an intimate contact with front substrate 21 and bus electrodes 221a, 222a, 231a, 232a. This is considered that firing at high temperatures allows indium (In) to be changed to transparent indium oxide (In₂O₃) and also enhances the contact between particles and with the substrate.

Besides, according to the embodiment, transparent electrodes 22b and 23b are formed of metal particles with an average particle diameter of 5 to 100 nm. Particles with an average particle diameter smaller than 5 nm easily causes reaction of the particles to the dielectric glass, and at the same time, easily causes a crack at the stepped section between the transparent electrodes and silver (Ag)-contained bus electrodes 221a, 222a, 231a, 232a. On the other hand, particles with an average particle diameter greater than 100 nm easily cause clogging in the minute nozzle of the inkjet applying equipment. Besides, if the average particle diameter becomes excessively large, the contact area between the particles after the firing process decreases, resulting in increased sheet resistance.

According to the embodiment, transparent electrodes 22b, 23b or wet layers 22bx, 23bx are firstly formed, and then bus electrodes 221a, 222a, 231a, and 232a are formed so as to cover the outer periphery section of transparent electrodes 22b, 23b or wet layers 22bx, 23bx. However, it is not limited to this. Bus electrodes 221a, 222a, 231a, and 232a may be firstly formed, and then transparent electrodes 22b and 23b may be formed. Hereinafter, the method for manufacturing such formed front panel will be described.

### Second Exemplary Embodiment

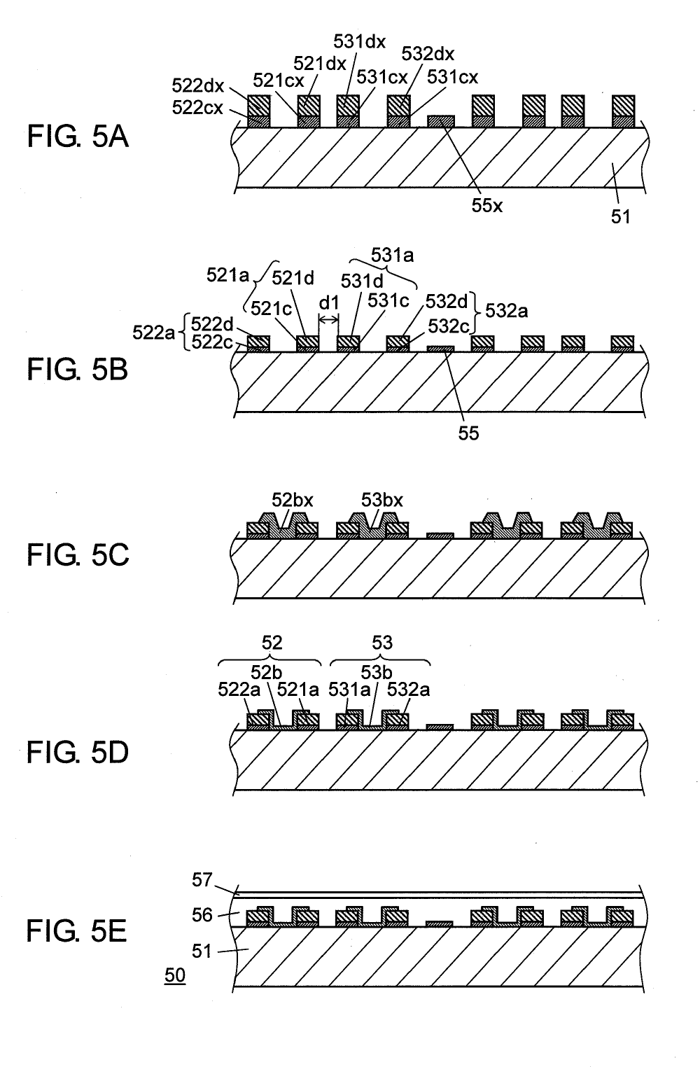

FIGS. 5A, 5B, 5C, 5D, and 5E illustrate the method for manufacturing the front panel of the panel in accordance with the second exemplary embodiment of the present invention.

As the first step of manufacturing front panel 50, glass-made front substrate 51 undergoes alkali cleaning.

Next, as shown in FIG. 5A, precursors 521cx, 522cx, 531cx, 532cx for black layers 521c, 522c, 531c, 532c, respectively, and precursor 55x for black stripe 55 are formed. The precursors are made of black layer paste containing ruthenium oxide (RuO₂) and black pigment as the main component. Here in the process above, the distance between precursors 521cx and 531cx determines distance d1 of a discharge gap. Next, precursors 521dx, 522dx, 531dx, 532dx for conductive layers 521d, 522d, 531d, 532d are formed on precursors 521cx, 522cx, 531cx, 532cx. The precursors for the conductive layers are made of conductive layer paste containing silver (Ag).

Next, as shown in FIG. 5B, bus electrodes 521a, 522a, 531a, 532a, and black stripe 55 are formed by firing front substrate 51 on which precursors 521cx, 522cx, 531cx, 532cx, 55x, 521dx, 522dx, 531dx, and 532dx have been formed. The peak temperature in the firing process should preferably be 550° C. to 600° C. In addition, the thickness of bus electrodes 521a, 522a, 531a, and 532a should preferably be 1 to 6 μm.

Next, transparent electrodes 52b and 53b are formed. First, a dispersion liquid containing any one of the following particles with an average particle diameter of 5 to 100 nm is prepared:
particles of metal formed of at least one of indium (In), tin (Sn), antimony (Sb), aluminum (Al), and zinc (Zn); particles of metal oxide formed of at least one of the metals above;
particles of alloy formed of two or more metals above; and
a mixture of the particles above.

Next, as shown in FIG. 5C, wet layers 52bx and 53bx are formed by applying the dispersion liquid so as to have a wide stripe shape with the use of an inkjet applying equipment. At that time, wet layer 52bx is formed so that the outer periphery section on the discharge gap side of wet layer 52bx is located on bus electrode 521a, and similarly, wet layer 53bx is formed so that the outer periphery section on the discharge gap side of wet layer 53bx is located on bus electrode 531a. At the same time, wet layer 52bx is formed so that a part of wet layer 52bx overlaps with at least a part of bus electrode 522a, and similarly, wet layer 53bx is formed so that a part of wet layer 53bx overlaps with at least a part of bus electrode 532a.

After that, as shown in FIG. 5D, front substrate 51 having wet layers 52bx and 53bx is dried and fired at temperatures ranging from 400° C. to 600° C. in an oxidizing atmosphere. Through the process, transparent electrodes 52b and 53b, which are made of a transparent conductive film with a thickness of 80-1000 nm, are formed.

Next, as shown in FIG. 5E, dielectric layer 56 and protective layer 57 are formed on front substrate 51 on which scan electrodes 52, sustain electrodes 53, and black stripes 55 have been formed.

First, the precursor for dielectric layer 56 is formed by screen printing or other heretofore known technique. The precursor for dielectric layer 56 is fired so as to form dielectric layer 56 with a thickness of 20 to 50 μm. After that, protective layer 27 having magnesium oxide (MgO) as the main component is formed on dielectric layer 26 by a vacuum deposition method or other heretofore known technique.

Also in the panel having front panel 50 manufactured by the method above, distance d1 of a discharge gap is not determined by the distance between transparent electrodes 52b and 53b but determined by the distance between bus electrodes 521a and 531a formed with high dimensional accuracy. The method of the embodiment allows a discharge gap to be formed with high dimensional accuracy, contributing to suppressed variations in discharge characteristics between discharge cells.

In the second embodiment, after precursors 521cx, 522cx, 531cx, 532cx, 521dx, 522dx, 531dx, and 532dx for black layers 521c, 522c, 531c, 532c, conductive layers 521d, 522d, 531d, 532d are fired, wet layers 52bx and 53bx are formed and fired, but it is not limited thereto. For example, scan electrodes 52 and sustain electrodes 53 may be formed in a manner that wet layers 52bx and 53bx are formed on precursors 521cx, 522cx, 531cx, 532cx, 521dx, 522dx, 531dx, and 532dx and then the precursors and the wet layers, i.e., 521cx, 522cx, 531cx, 532cx, 521dx, 522dx, 531dx, 532dx, 52bx, and 53bx are fired at the same time.

According to the description of the embodiment, the scan bus electrode is formed of two bus electrodes 521a, 522a, and similarly, the sustain bus electrode is formed of two bus electrodes 531a, 532a. However, the present invention is not limited to the structure above.

### Third Exemplary Embodiment

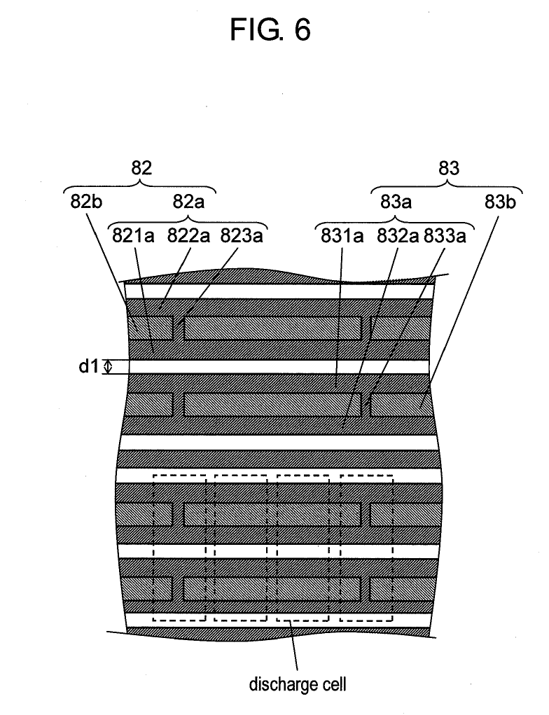

FIG. 6 is a view showing the detailed structure of the display electrode pairs of the panel in accordance with the third exemplary embodiment of the present invention. Scan electrode 82 has transparent electrode 82b and ladder-shaped scan bus electrode 82a. Similarly, sustain electrode 83 has transparent electrode 83b and ladder-shaped sustain bus electrode 83a.

Scan bus electrode 82a has bus electrode 821a, bus electrode 822a, and bus electrode 823a. Bus electrode 821a, which corresponds to one of the two long bars of the “ladder”, defines a discharge gap. Bus electrode 822a, which corresponds to the other of the two long bars, enhances the conductivity of scan electrode 82. Bus electrode 823a, which corresponds to a “step” of the ladder, reduces resistance between bus electrodes 821a and 822a. Similarly, sustain bus electrode 83a has bus electrode 831a, bus electrode 832a, and bus electrode 833a. Bus electrode 831a corresponds to one of the two long bars of the “ladder” and defines a discharge gap. Bus electrode 832a corresponds to the other of the two long bars and enhances the conductivity of sustain electrode 83. Bus electrode 833a corresponds to a “step” of the ladder and reduces resistance between bus electrodes 831a and 832a.

Also in bus electrodes 82a and 83a structured above, distance d1 of a discharge gap is not determined by the distance between transparent electrodes 82b and 83b but determined by the distance between bus electrodes 821a and 831a formed with high dimensional accuracy. Therefore, forming bus electrodes 821a and 831a with high dimensional accuracy contributes to an accurately formed discharge gap, suppressing variations in discharge characteristics between discharge cells.

Besides, the structure above reduces each resistance between bus electrodes 821a and 822a and between bus electrodes 831a and 832a, enhancing stability in discharge generation. FIG. 6 shows bus electrodes 823a and 833a disposed in one of three consecutive discharge cells, but it is given as an example; bus electrodes 823a and 833a are arbitrarily disposed as necessary.

Specific values seen in the description of the first through the third exemplary embodiments are cited merely by way of example. They should be optimally determined according to characteristics of a panel.

### INDUSTRIAL APPLICABILITY

According to the present invention, the panel has a transparent electrode, which is formed by firing a dispersion liquid containing particles of metal or particles of metal oxide. Such formed transparent electrode is low cost and suppresses variations in discharge characteristics between discharge cells, allowing the panel to display image with high quality. The present invention is thus useful for a panel and a method for manufacturing the panel.

### REFERENCE MARKS IN THE DRAWINGS

10 panel
20, 50 front panel
21, 51 front substrate
22, 52, 82 scan electrode
22b, 23b, 52b, 53b, 82b, 83b transparent electrode
22bx, 23bx, 52bx, 53bx wet layer
23, 53, 83 sustain electrode
24 display electrode pair
25, 55 black stripe
25x, 55x precursor (for black stripe)
26, 56 dielectric layer
27, 57 protective layer
30 back panel
31 back substrate
32 data electrode
32x precursor (for data electrode)
33 base dielectric layer
34 barrier rib
35 phosphor layer
82a, 83a, 221a, 222a, 231a, 232a, 521a, 522a, 531a, 532a, 821a, 822a, 823a, 831a, 832a, 833a bus electrode
221c, 222c, 231c, 232c, 521c, 522c, 531c, 532c black layer
221cx, 222cx, 231cx, 232cx, 521cx, 522cx, 531cx, 532cx precursor (for black layer)
221d, 222d, 231d, 232d, 521d, 522d, 531d, 532d conductive layer
221dx, 222dx, 231dx, 232dx, 521dx, 522dx, 531dx, 532dx precursor (for conductive layer)

1. A plasma display panel comprising:
a plurality of display electrode pairs on a front substrate, the display electrode pairs each of which formed of a pair of a scan electrode and a sustain electrode having a discharge gap therebetween,
wherein the scan electrode has a scan bus electrode and a scan transparent electrode, and the sustain electrode has a sustain bus electrode and a sustain transparent electrode,
the scan bus electrode and the sustain bus electrode are formed on the front substrate so as to form the discharge gap, and
the scan transparent electrode and the sustain transparent electrode are formed with use of a dispersion liquid containing particles of metal or particles of metal oxide in a manner that an outer periphery section on a discharge gap side of the scan transparent electrode overlaps with the scan bus electrode and an outer periphery section on a discharge gap side of the sustain transparent electrode overlaps with the sustain bus electrode.

2. The plasma display panel of claim 1,
wherein the particles of the metal or the particles of the metal oxide contain indium and tin.

3. A method for manufacturing a plasma display panel, the plasma display panel with a plurality of display electrode pairs on a front substrate, the display electrode pairs each of which formed of a pair of a scan electrode and a sustain electrode having a discharge gap therebetween,
wherein the scan electrode has a scan bus electrode and a scan transparent electrode, and the sustain electrode has a sustain bus electrode and a sustain transparent electrode,
the method comprising:
forming the scan bus electrode and the sustain bus electrode on the front substrate so as to form the discharge gap; and
forming the scan transparent electrode and the sustain transparent electrode by using a dispersion liquid containing particles of metal or particles of metal oxide in a manner that an outer periphery section on a discharge gap side of the scan transparent electrode overlaps with the scan bus electrode and an outer periphery section on a discharge gap side of the sustain transparent electrode overlaps with the sustain bus electrode.

4. The method for manufacturing a plasma display panel of claim 3,
wherein the dispersion liquid is applied by an inkjet method.
